(19) United States
(12) Patent Application Publication
(10) Pub. No.: US 2016/0042445 A1
(43) Pub. Date: Feb. 11, 2016

(54) System and Method for Recurrent Rental Vehicle Location and Rate Selection Using Network Based Data

(71) Applicant: Carroll Tim Beason, San Diego, CA (US)

(72) Inventor: Carroll Tim Beason, San Diego, CA (US)

(21) Appl. No.: 14/820,492

(22) Filed: Aug. 6, 2015

Related U.S. Application Data
(60) Provisional application No. 62/034,121, filed on Aug. 6, 2014.
(60) Provisional application No. 62/187,813, filed on Jul. 1, 2015.

(51) Int. Cl. G06Q 30/06; G06F 17/30; G06Q 10/02

(52) U.S. Cl. CPC G06Q 30/0645; G06Q 10/02; G06F 17/30867; G06F 17/30412

(57) ABSTRACT

Disclosed is a system and service for rental vehicles by providing an improved and streamlined booking experience. A user interfaces with the central system through a website or mobile application where the user's location is provided to the system. The system then uses such information to identify rental companies within a specified geographic location relative to the user's location and rental preferences. A user is then presented with rental choices located in the geographical area where the user may then select and reserve a particular rental. The central system may also provide rental information to car vendors, rate management companies, and third party transportation providers. Other travel related services may use data from the central system. The system may also use geo location services from an outside provider to provide mapping services and other geographical information.

### RELATED APPLICATIONS

This utility patent application claims the benefit of priority to, and incorporates by reference, U.S. Provisional Patent Application Ser. No. 62/034,121, entitled “Travcar System and Method for Recurrent Rental Car Location and Rate Selection Using Network Based Data”, filed on Aug. 6, 2014, and currently co-pending, and also claims the benefit or priority to U.S. Provisional Patent Application Ser. No. 62/187,813, entitled “System and Method for Recurrent Rental Vehicle Location and Rate Selection Using network Based Data”, filed in Jul. 1, 2015, also currently co-pending.

### FIELD OF THE INVENTION

The invention relates generally to vehicle rental aggregation reservation services and more particularly, though not exclusively, to a software application designed to utilize a user's location to aggregate and locate rental vehicle companies based on user preferences; such as distance of the rental agency from the user and the pricing of vehicles. This may be more specifically described as GEO Locating users near GEO Located vehicle rental vendors on an electronic map screen via desktop computing or mobile cell phone device computing.

### BACKGROUND OF INVENTION

The rental vehicle reservation booking industry is somewhat antiquated in its large number of steps required to produce a vehicle rental reservation. Most facilitate booking reservations for numerous industries, such as rental vehicle, hotel, airline, and cruise ships; adding to the number of reservation steps to simply book a reservation for a rental vehicle. Many of the popular web-based aggregators facilitate booking for numerous industries thereby including various unnecessary steps to book a rental vehicle. In these popular web-based aggregators, the interface is hard to navigate when multiple industries are displayed. To get pass the various other travel industries, you must take additional steps to exclude those additional industries. This makes booking a vehicle rental overwhelming, troublesome, and frustrating.

My competition is trying to do too many things for too many industries; adding to the steps it takes to book, singularly, a rental vehicle. For example; Expedia.com, Orbitz.com, and Priceline.com are booking reservations for numerous travel industries. This process is slowing the booking process for those seeking only a rental vehicle reservation. Additionally; the travel reservation industry is behind in current mobile and GEO locating based technology. My invention will improve upon current mobile and desktop computing, vehicle rental reservation technology.

Further, there are only a few online aggregators that will book reservations singularly for vehicle rentals. Vendor operators such as Hertz will display rates exclusively for the vehicle rental industry, but only for their brand. The most successful singular vehicle rental online booking aggregator, Car Rentals.com, will query and display results for as many as one hundred or more vendor vehicle choices. The sheer amount of information to navigate may overwhelm a user. This will result in the user making a less than optimal pricing and servicing choice when booking a vehicle rental from an agency.

As mentioned earlier often times potential users are overwhelmed when reserving a rental vehicle due to said vast amounts of information. As a result users may commonly rely on third-parties to provide recommendations. Said third-parties often include hoteliers, concierges, travel agents, and other hospitality or travel industry employees; predictably those who may have more experience with car rental reservations specific to their working location or expertise. However, as a worker on the job, said third parties are taking valuable time away from their job to provide information about a vehicle rental service. Likely they may only provide this information because specific vendors are providing a commission; thus their advice may not necessarily be in the best interest of the user.

In light of the above, it would be advantageous to provide a software application for travel aggregation services singularly focused on vehicle rental. Further a software application capable of retrieving a user's location and providing the user with the nearest rental companies sorted by distance, price, and other User preferences; thus optimizing user experience. It would further be advantageous to provide a software application for vehicle rental aggregation services capable of sorting and displaying an optimal number of retrieved results negating information overload. It would further be advantageous to provide a software application for vehicle rental aggregation services which links a User and their third-party referral counterparts to unbiased recommendations while still compensating third-parties for said recommendations to users. It would be further advantageous to provide a software application for vehicle rental aggregation services built on web-based and mobile technology for utilization on mobile devices to increase portability, accessibility, and ease of use.

### SUMMARY OF THE INVENTION

The System of this present invention is designed to service only vehicle rental customers and provide an improved booking experience by streamlining the process of booking a rental vehicle to include only three primary steps for the User. The System is designed to minimize the amount of displayed results to the User, to eliminate and minimize the occurrence of information overload, and narrow displayed results for the User. A typical vehicle rental aggregation booking service will query and display results for as many as one hundred or more vendor vehicle choices which may overload the User with information. Information overload occurs because the amount of information presented to the User exceeds the processing capacity of the User at that particular point in time. In certain instances, the User may have a fairly limited cognitive processing capacity such as when in a new location, when time is limited, or during times of high stress. Consequently, when information overload occurs, it is likely that a reduction in decision quality will occur. The User would not be able to make the best decision regarding which vehicle rental agency to choose. By minimizing, yet optimizing, the amount of information presented to the User, information overload is avoided allowing the User to make better, well-informed choices.

Our System is a vehicle rental reservation system, which integrates proprietary software programs, hardware systems and telecommunication technologies to provide a system for Users to book a vehicle rental reservation in a minimum of three steps, thereby streamlining the process of booking a rental vehicle. The System includes a data center in communication with multiple optional User Terminals, in some cases a Promoter Terminal, and multiple Rental Agencies. The communication between the Data Center and the various components will be completed through the utilization of a Proprietary Database using GDS connectivity, GEO Locating technology, Direct Vendor Connect technology, and Map Display technology developed in the Cloud. Booking a vehicle rental through the System includes the three step process of providing a User location near appropriate aggregated vehicle rental agencies, choosing a vehicle from a selected vehicle rental agency, and booking the selected vehicle from said agency.

In a preferred embodiment of the system, the system focuses on a single industry, specifically the vehicle rental industry. By focusing on the vehicle rental industry only, the additional layers of complexity involved with multiple industry aggregation services are removed. The System locates rental vehicle agencies relative to the location of a User. The System limits the displayed results of queried Rental Vehicle Agencies to typically no more than a dozen results by eliminating the hundreds of choices current aggregators' option when adding car class to the initial display. It will identify the base price of located rental vehicle vendors and identify the mileage distance between the users and vendor agencies. By providing processing of aggregated results for the User and limiting the amount of information displayed to the User based on User preferences, the information is streamlined for better processing by the User enabling the user to make better, well-informed decisions.

The User location is determined by using GEO Locating technology or through manual user input. After User location is submitted to the System, the system utilizes proprietary geographic algorithms to determine, via Worldspan GDS technology, Sabre GDS technology, Google Map Technology, GEO locating Technology, or Direct Vendor Connect technology rental agency locations that encompass the nearest optimal vendor locations in its list of vehicle rental agencies options. The vehicle rental agencies are displayed to the User along with additional rental agency information, the distance from the User and the base vehicle rental price for each agency. Upon the user choosing a vehicle rental agency from the list, the System sends a request to the chosen vehicle rental agency for up-to-date, real-time prices of its additional vehicle classes. Said additional vehicle classes are again proprietarily delivered and displayed. The User selects a desired vehicle and confirms to complete the booking of a rental vehicle from the rental agency.

Within the System, retail first time Users, Member Users, and Promoters are allowed access to the system. Retail users can use the system with limited access, while Member Users and Promoters are recognized through their Personal Profiles. Personal Profiles allow the Member User or Promoter to log into the system and utilize additional services. Promoters are able to create Member User Profiles, and to book rental vehicles for Member Users. Member User Profiles allow a Member User to access the System to update their profile, book rental vehicles, check their rental reservation history, discover promotions, and other added benefits. Each Member User Profile, if initially introduced to the system by a Promoter, is linked to a Promoter Profile through the use of a unique Promoter Identification Code embedded into the Member User Profile during Member User registration. The linked Promoter allows the Promoter to receive credit whenever a Member User books a rental vehicle utilizing the System and their Member User Profile. By providing a more streamlined service for Users to book vehicle rentals and providing incentives for Promoters, the System provides all Users with an improved customer experience for booking rental vehicles.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a diagrammatic view of the system of the present invention showing the system components including the data center, Promoter Terminal, User Terminals, rental agencies and the Cloud;

FIG. 2 is a diagrammatic view of a computing device used as a Promoter Terminal;

FIG. 3 is a diagrammatic view of a computing device used as a User Terminal;

FIG. 4 is a flow chart showing the steps of installing the System software onto a computer device to function as a Terminal;

FIG. 5 is a flow chart depicting the steps of creating a Promoter Profile with unique Promoter Identification Code using a Promoter Terminal;

FIG. 6 is a flow chart depicting the steps of creating a User Profile with a permanently associated Promoter Identification Coded on the Promoter Terminal and the installation of the System software on a User's mobile computing device to function as a User Terminal;

FIG. 7 is a diagram of the graphical user interface of the Promoter Terminal Software showing the User Profile registration splash screen;

FIG. 8 is a flow chart depicting the steps of booking a vehicle with the System using either a Promoter Terminal or the User Terminal;

FIG. 9 is a flow chart depicting the steps of retrieving User location utilizing the Promoter Terminal or the User Terminal;

FIG. 10 is a flow chart depicting the steps of aggregating and querying vehicle rental Agencies within the vicinity of the User's location matching the User's preferences;

FIG. 11 is a diagram of the graphical user interface of the Promoter Terminal Software showing the Agency Selection splash screen showing the location of the User and the corresponding Agencies within the vicinity of the User matching the User's specifications;

FIG. 12 is a diagram of the graphical user interface of the Promoter Terminal Software showing the Vehicle Selection splash screen showing the selected Agency's available vehicles;

FIG. 13 is a flow chart depicting the steps of selecting a desired vehicle from the selected Agency;

FIG. 14 a diagram of the graphical user interface of the Promoter Terminal Software showing the Vehicle Reservation Confirmation splash screen showing the selected vehicle, the rate, and the duration of the rental;

FIG. 15 is a flow chart depicting the steps of reserving the selected vehicle from the selected Agency;

FIG. 16 is a diagram of the graphical user interface of the Promoter Terminal Software showing the confirmation page of the System;

FIG. 17 is a diagram of a Rental Agency Interface of the User Terminal;

FIG. 18 is a diagram of a Rental Vehicle Interface of the User Terminal;

FIG. 19 is a diagram of a Reservation Interface of the User Terminal;

FIG. 20 is a diagram of the Reservation Information Interface of the User Terminal;

FIG. 21 is a diagram of a Detailed Reservation Summary; and

FIG. 22 is a schematic diagram of the System showing the communication links between the System application and related services.

### DETAILED DESCRIPTION OF THE DRAWINGS

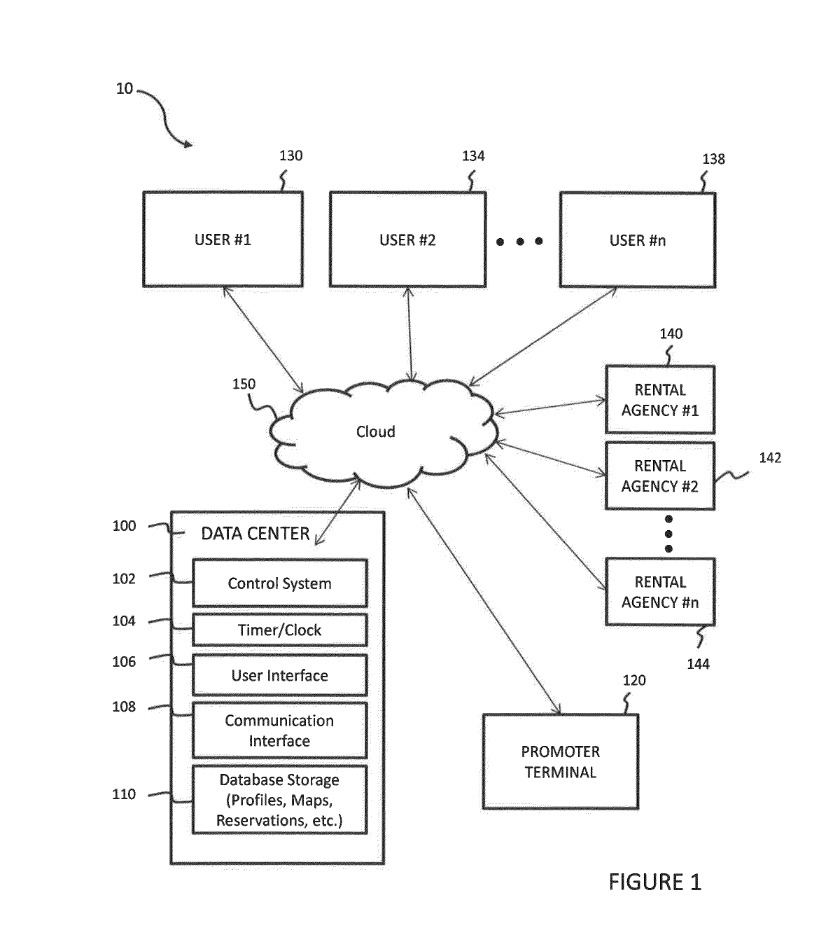

Referring initially to FIG. 1, a diagram of the System of the present invention is shown and generally designated 10. The System 10 is a vehicle rental system which integrates proprietary software programs, hardware systems and telecommunication technologies to provide a system for Users to book a rental vehicle in a minimum of four steps, thereby streamlining the process of booking a rental vehicle.

A typical vehicle rental aggregation booking service will query and display results for as many as one hundred or more vendor vehicle choices. The number of displayed results overloads the User with information where the overwhelming number of search results will be difficult for the User to sort through and make the best decision on which vehicle rental agency to choose. The information overload occurs because the amount of information available to the User exceeds the processing capacity of the User at a particular point in time. In certain instances, the User may have a fairly limited cognitive processing capacity such as when in a new location, when time is limited, or during times of high stress. Consequently, when information overload occurs, it is likely that a reduction in decision quality will occur. The User would not be able to make the best decision regarding which vehicle rental agency to choose.

Further, the typical vehicle rental aggregation booking service is coupled with aggregation services for several different industries such as hotels and flights. Any addition of any industry adds additional layers of complexity to booking a rental vehicle. The additional layers of complexity slow the booking process for those seeking only a rental vehicle reservation by requiring the navigation of the booking service to work around the undesired industry menus and information. Additionally, the multiple industry aggregation services currently available are behind in current mobile based technology due to the overwhelming complexity of their services.

In a preferred embodiment, the System 10 is designed to service only rental vehicle customers and provide an improved booking experience by streamlining the process of booking a vehicle to four steps. The System 10 is designed to minimize the amount of displayed results to the User to eliminate and minimize the occurrence of information overload by processing and narrowing the aggregated results for the User. The aggregated search results are queried and sorted based on the geographically closest and best matched vehicle rental agencies according to the User's location, information and preferences. As a result, two and up to as many as six optimum vendor choices will be displayed from the entirety of aggregated agencies. The User will be better able to process the optimized amount of information resulting in a better, well-informed decision.

By focusing on the vehicle rental industry only, the additional layers of complexity involved with multiple industry aggregation services are removed. The additional options, menus, and navigational requirements of the multiple industry aggregation services are not present in the System 10. As a result, the System 10 will require a minimum of only four steps to complete the rental vehicle booking process. Further, the streamlining of the booking process allows the integration of the proprietary software not only in desktop workstations but into individual User devices such as tablets and mobile smartphones.

As shown in FIG. 1, the System 10 includes a data center 100 in communication with multiple User Terminals One 130, User Terminal Two 134, User Terminal N 138, at least one Promoter Terminal 120, Rental Agency One 140, Rental Agency Two 142, and Rental Agency N 144. The communication between the Data Center 100 and the various components may be completed through the utilization of a Cloud 150. However, it is contemplated that communication between the various components may be achieved using various other telecommunication methods such as satellite, wireless communications, internet based connections, and wire based connections.

The Data Center 100 includes at least a control system 102, a timer/clock 104, a user interface 106, a communication interface 108, a database storage 110 all in communication with one another.

The control system 102 controls the overall functionality of the Data Center 100. The control system 102 of the present invention may include a central processing unit, multiple microprocessors, and various other computing components to help accomplish the control of the overall operation of the Data Center 100. The control system 102 is in communication with the database storage 110, the timer/clock 104, and the user interface 106, the communication interface 108. Control system 102 controls the overall operation of the Data Center 100, including the coordination of the other components with each other. The control system 102 operates with a proprietary database software program created with a .NET platform.

Timer/clock 104 provides timing and clock functions for the Data Center 100 and ensures that each component of the Data Center 100 is synced to the timer/clock 104. This enables the accurate interaction of the components with each other. The timer/clock 104 also has a system clock to provide accurate current system time for the Data Center 100. Based on the current system time provided by the timer/clock 104, the Data Center 100 can sync itself to various external systems which have also synced itself to current system time to allow proper communication such as the Cloud 150, the User Terminals 130, 134, and 138 respectively, the rental agencies 140, 142, and 144 respectively, and the Promoter Terminal 120.

The user interface 106 provides a system administrator with the ability to interface with the Data Center 100 to set the various parameters associated with the Data Center 100. The system administrator can interface through a keypad, a touchscreen, a Bluetooth connected device, or an application that resides on an external computing device such as a home computer, a tablet, or a smartphone in order to operate, manage, and maintain the Data Center 100.

Communication interface 108 allows the Data Center 100 to communicate with the various other external components of the System 10 such as the cloud 150, the User Terminals 130, 134, and 138 respectively, the rental agencies 140, 142, and 144 respectively, and the Promoter Terminal 120. The communication between the Data Center 100 and the various external systems allows the Data Center 100 to provide the user with up to date information on the closest available vehicle rental agency, vehicle rental rates, and various other collected data. In a preferred embodiment, the Simple Object Access Protocol (SOAP) is used to communicate between the Data Center 100 and the User Terminals 130, 134, and 138 respectively, the rental agencies 140, 142, and 144 respectively. While this communication protocol is particularly well suited for the present invention, it is to be appreciated that other existing communication protocols may be used alone or in combination, or a proprietary communication protocol may be incorporated herein without departing from the spirit and scope of the present invention.

The database storage 110 is stores data in electronic format for read/write access by the Data Center 100. The database storage stores information such as map data, profile data, and reservation data. The database storage 110 stores world-wide maps for easy access and the locations of vehicle rental agencies throughout the designated areas of coverage. The maps stored in the storage database 102 also provide a point of reference for the location of the User Terminals 130, 134, and 138 respectively, or the Promoter Terminal 120 once located. The storage database 110 also stores all of the reservation data created by the Users of the System 10. Along with reservations stored on the individual User Terminals 130, 134, and 138 respectively, and Promoter Terminals 120, the reservations are stored in the storage database 110 to allow the Users, the Promoters, and the vehicle Rental Agencies to access the reservations. Further, the User Profiles and Promoter Profiles of the System 10 are stored within the database storage 110.

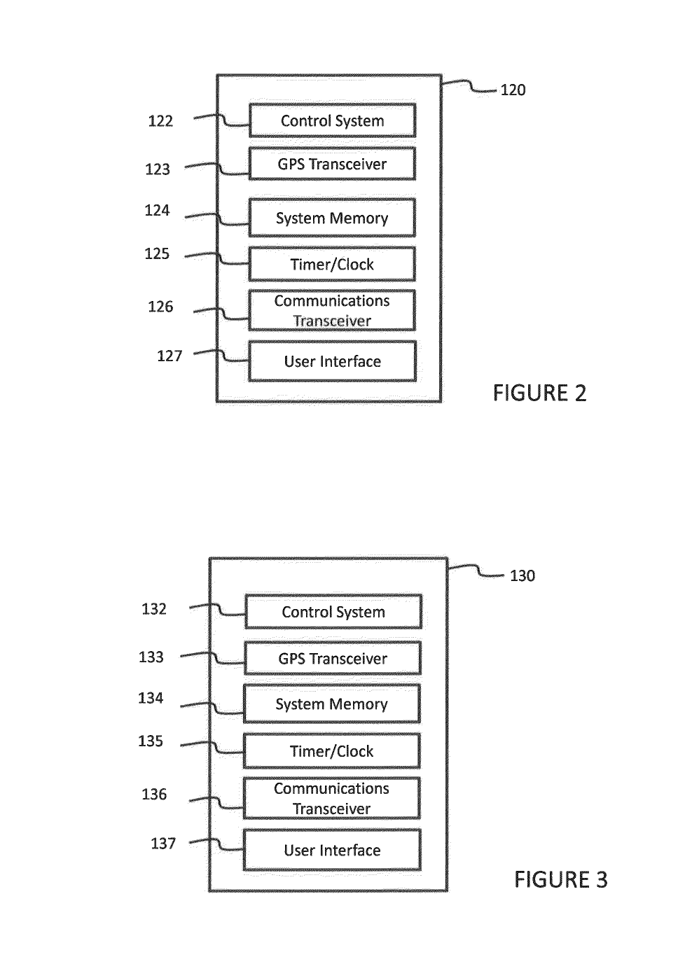

The Promoter Terminal 120, described in conjunction with FIG. 2, includes at least a control system 122, a GPS transceiver 123, a system memory 124, a timer/clock 125, a communications transceiver 126, and a user interface 127. The User Terminal 130, described in conjunction with FIG. 3, includes at least control system 132, a GPS transceiver 133, a system memory 134, a timer/clock 135, a communications transceiver 136 and a user interface 137, which is substantially similar to Promoter Terminal 130. As a result, only the Promoter Terminal 120 will be described in detail wherein all of the descriptions of similar and like parts of the Promoter Terminal 120 are incorporated into the description of the User Terminal 130.

The control system 122 controls the overall functionality of the Promoter Terminal 120. The control system 122 of the present invention may include a central processing unit, multiple microprocessors, and various other computing components to help accomplish the control of the overall operation of the Promoter Terminal 120. The control system 122 is in communication with the GPS transceiver 123, the system memory 124, the timer/clock 125, the communications transceiver 126, and the user interface 127. Control system 122 controls the overall operation of the Promoter Terminal 120, including the coordination of the other components with each other. The control system 122 operates with a proprietary Promoter/User Terminal GUI Program built using the LAMP software bundle technology.

The control system 122 processes the location of the Promoter Terminal 120 through the use of the onboard GPS transceiver 123 or through the use of measurable physical markers gathered through the various telecommunication connections. The GPS transceiver 123 provides accurate location and time information through the use of GPS satellites. The control system 122 of the Promoter Terminal 120 may also locate itself by using the known physical address of a wired connection in which it is connected or various other known methods in the art.

Timer/clock 125 provides the timing of the Promoter Terminal 120 and ensures that each component of the Promoter Terminal 120 is synced to the timer/clock 125. This enables the accurate interaction of the components with each other. The timer/clock 125 also has a system clock to provide accurate current system time for the Promoter Terminal 120. Based on the current system time provided by the timer/clock 125, the Promoter Terminal 120 can sync itself to the Data Center 100 to communicate between the Data Center 100 and the Promoter/User Terminal GUI Program to receive real-time updates on local vehicle rental agencies and the availability and pricing of the rental vehicles.

The user interface 127 provides the Promoter with the ability to interface with the Promoter Terminal 120 to set the various parameters required to book a vehicle rental from a vehicle rental agency. The Promoter can interface through a keypad, a touchscreen or any other external input device to input the required parameters. Using the user interface 127, the Promoter may input the desired rental period duration, override the automatic GPS locator with a User inputted location, select a vehicle rental company, select a rental vehicle type, or the other various inputs required to book a vehicle rental.

Communication interface 127 allows the Promoter Terminal 120 to communicate with the Data Center 100 either through the cloud 150 or other telecommunication methods. The communication between the Promoter Terminal 120 and the Data Center 100 provides the user with up to date information on the closest available vehicle rental agency, vehicle rental rates, and various other collected data. Further, it enables the user to reserve and book a rental. In a preferred embodiment, the SOAP Simple Object Access Protocol is used. While this communication protocol is particularly well suited for the present invention, it is to be appreciated that other existing communication protocols may be used alone or in combination, or a proprietary communication protocol may be incorporated herein without departing from the spirit and scope of the present invention.

The system memory 124 allows read and write of information. The data of the Promoter Terminal 120 is stored within the system memory 124 which allows the various components of the Promoter Terminal 120 access. The stored data in the system memory 124 is also provided to the Data Center 100 for the vehicle rental booking process. Information such as the location gathered from the GPS transceiver 123 or through user input through the user interface 127, as well as information inputted through the user interface 127 regarding the duration of the vehicle rental and other selected options.

The Rental Agencies 140, 142, and 142 respectively, are in communications with the Data Center 100 through the cloud 150 or various other telecommunications methods. The Data Center 100 has the capability to receive and transmit data to the Rental Agencies 140, 142, and 142 respectively, in real-time to retrieve real-time locations of the closest rental vehicle agencies, rental vehicle availability, rental vehicle rates as well as to book reservations. The Data Center 100 utilizes Worldspan Global Distribution System technology to communicate with connected Rental Agencies 140, 142, and 142 respectively.

In the preferred embodiment, the Promoter Terminal 120 is a desktop computer operating with the proprietary Promoter/User Terminal GUI program installed. The Promoter/User Terminal GUI program operates in conjunction with the operating system software of the desktop computer. The Promoter/User Terminal GUI program installed on the desktop computer serves as the Promoter Terminal 120. However, it is contemplated that the Promoter Terminal 120 may by a tablet computer with the installed Promoter/User Terminal GUI program. In the preferred embodiment, the User Terminal 120 is a smartphone.

The Data Center 100 serves as the processing center of System 10 and controls the processes required to book a rental vehicle. When a Promoter accesses the Promoter Terminal 120 or the User accesses a User Terminal 130, the Data Center 100, using GPS technology algorithms, will pin locate the Promoter or User on a map stored in the database storage 110 according to the location communicated by the Promoter Terminal 120 or User Terminal 130, respectively. The Data Center 100 will then use geographic algorithms to determine the locations of rental vehicle agency 140, 142, and 144 that encompass the nearest two to six locations. Once rental vehicle agency 140, 142, and 144 names and locations are determined by the Data Center 100, a query will be sent to the identified rental vehicle agency 140, 142, and 144 returning real time prices of the Agency's base cost rental cars. The Promoter Terminal 120 or User Terminal 130 will display silhouettes on a map with vehicle agency 140, 142, and 144 names, distance from the Promoter's or User's pinned GPS location and vendors base price.

When the Promoter or User selects a preferred vehicle agency 140, 142, and 144 after evaluating the available choices using the User Interface 127 or User Interface 137 from the Promoter Terminal 120 or User Terminal 130, respectively, a query will be sent from the Promoter Terminal 120 or the User Terminal 130 to the Data Center 100, which will then query the chosen Agency for real-time results of five to six additional vehicle class prices via the Worldspan GDS technology. The additional five to six vehicle choice prices will be sent from the Data Center 100 to the Promoter Terminal 120 or User Terminal 130 and displayed in a subsequent second screen for a modified selection by the Promoter or User. The Promoter or User will also select date and time ranges on the second screen. When the Promoter or User narrows the choices of the search selections using the above parameters they will cause the Data Center 100 to send a query for the narrowed search parameters to the selected Agency returning real-time results for total cost including all taxes and fees. This query result will be displayed and represent name of Agency, itemized total cost of chosen rental vehicle, and chosen rental vehicle description. If all is acceptable by the Promoter or the User, they will book the rental vehicle.

Booking the rental vehicle will launch a reservation submission to chosen Agency. After receiving the booking confirmation from the Promoter Terminal 120 or the User Terminal 130, the Data Center 100 with send the confirmation to the Agency which will return a confirmation reservation including a reservation number in real-time to the Data Center 100. The Data Center 100 sends all of the information to the Promoter Terminal 120 or the User Terminal 130. This compilation of results will be displayed on the fourth screen in a reservation format, a text and email will be sent to the Promoter Terminal 120 or the User Terminal 130 enhancing accessibility of reservation, and a final copy of the reservation compilation will be logged in the reservation database file within the database storage 110 of the data center 100 and available for anytime access.

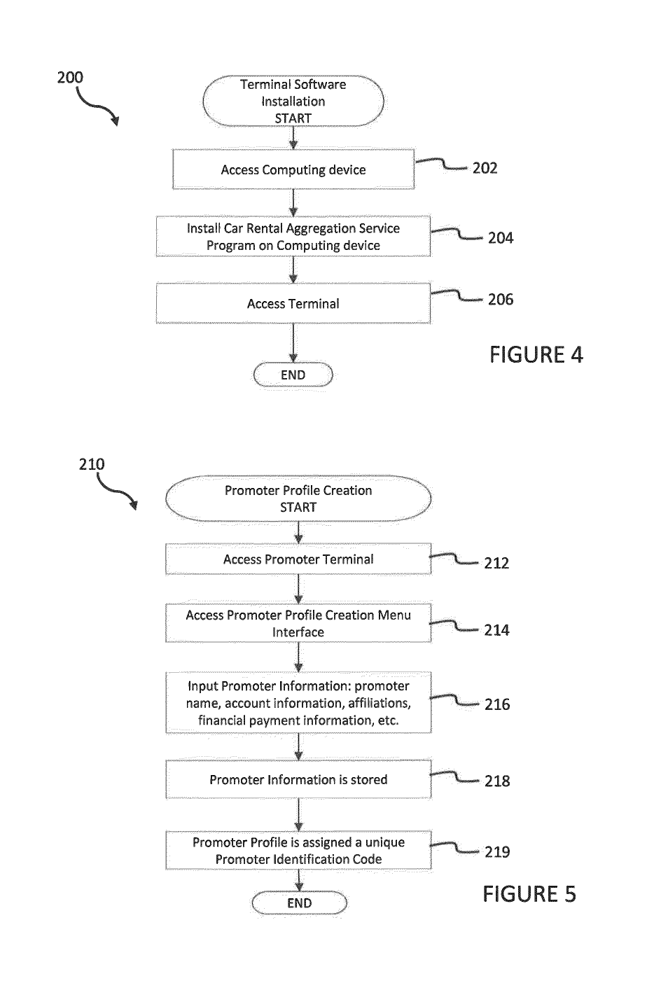

Referring now to FIG. 4, a flow chart describing the steps of installing the Promoter/User Terminal GUI program on a computing device for use as a Promoter Terminal 120 or a User Terminal 130 is shown and generally designated 200. To install the Promoter/User Terminal GUI program, the computer device is first accessed 202. The computing device in step 202, in the preferred embodiment, is a desktop computer. However, it is contemplated that the computer device may be tablet or mobile phone. In the next step 204, the Promoter/User Terminal GUI program is installed into the computing device. In step 206, the Promoter/User Terminal GUI program is opened to complete the installation.

Referring now to FIG. 5, a flow chart describing the steps of creating a Promoter Profile using the Promoter Terminal 120 is shown and generally designated 210. In step 212 the Promoter Terminal 120 is accessed. After accessing the Promoter Terminal 120, a Promoter Profile creation screen is accessed in step 214. In step 216, the information of the Promoter is inputted into the Promoter Profile. The information inputted for the Promoter Profile includes: the Promoter name; account information including contact phone number and address; affiliations such as hotel or rental agency; financial payment information including credit card and bank account information; and various other desired information. In step 218, all the information is stored into a Promoter Profile in the database storage 110 of the data center 100 for the Promoter and the Promoter Profile is assigned with a unique Promoter Identification Code in Step 219.

The unique Promoter Identification Code links a Promoter with the Promoter's Promoter Profile. Based only on the Promoter Identification Code, the System 10 may access any information regarding that particular Promoter for use in the System 10. The Promoter Identification Code is utilized to permanently link a Promoter with a User Profile and User Terminal 130. By linking the User Profile and User Terminal 130 with a Promoter, whenever a User accesses their User Profile and User Terminal 130 to book a rental vehicle, the Promoter is credited with the booking.

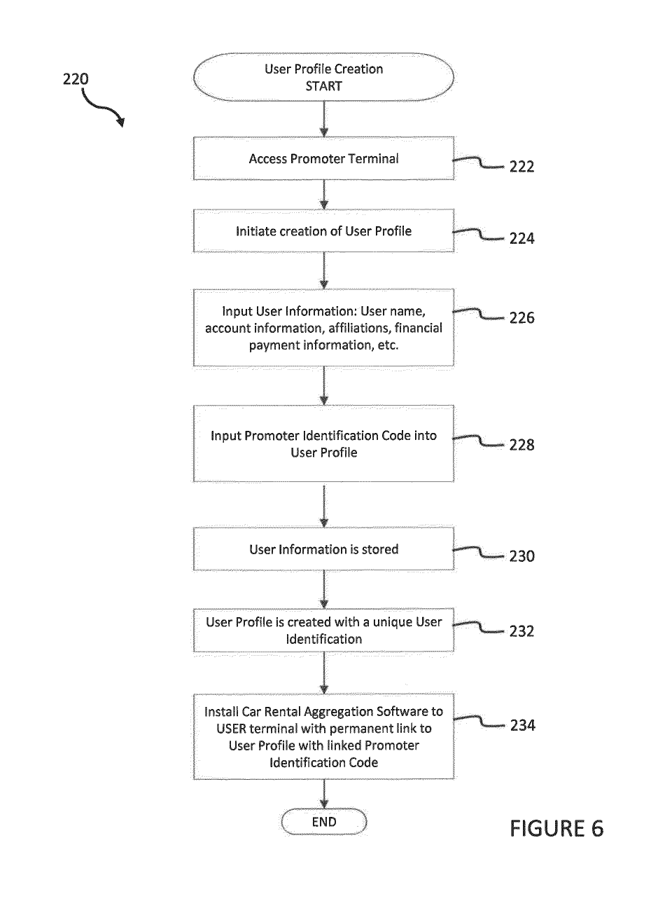

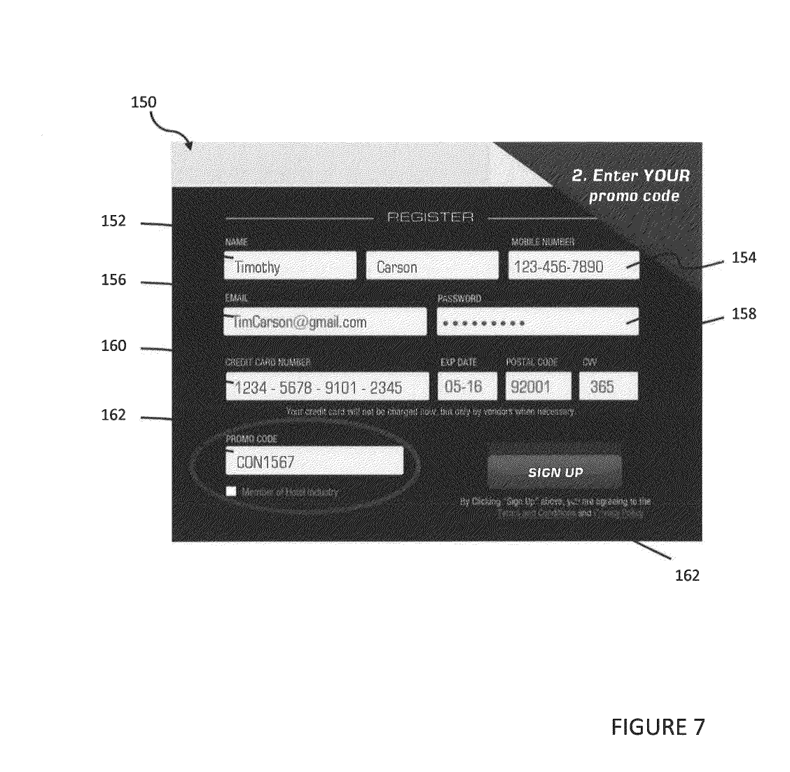

Referring now to FIG. 6, a flow chart depicting the steps of creating a User Profile is shown and generally designated 220. The first step 222 of creating a User Profile is to access the Promoter Terminal installed on computing device such as a desktop computer. The next step 224 is to access the User Profile Registration screen 150 (shown in FIG. 7) through the Promoter Terminal 130. After accessing the User Profile Registration screen, the next step 226 is to input all of the various User Information such as name, phone number, e-mail, password, credit card information, and Promoter Identification Code. Additionally, a Promoter Identification Code is also input into the User Profile to permanently link the Promoter with the User Profile in step 228. As shown in FIG. 7, the User Profile Registration Screen 150 includes data fields to input a name 152, a mobile number 154, an e-mail address 156, a User Profile password 158, credit vehicle information 160, and a Promoter Identification Code 162.

Referring back to FIG. 6, the information is stored in the Data Center 100 database storage 100 in step 230 and a User Profile with a unique User Identification number is created in step 232. The User Identification allows the System 10 to differentiate between the multitude of different Users which may be accessing the System 10 at one time. It further serves as a unique identifier to link the User Profile with the User when the User is picking up a rental vehicle after booking a vehicle and serves as an electronic identifier for a User which may also be used as a physical identifier for the person in real-life. After the creation of the User Profile, the User may use the User Profile to begin booking vehicles using the System 10.

By permanently linking the User Profile with the Promoter Profile, the Promoter is credited with every booking the User makes using the System 10. This provides the Promoter with a referral commission for introducing the System 10 to the program. By permanently linking the Promoter Profile with the User Profile, the Promoter is credited for any subsequent booking made by the User using the User Profile and booking through the System 10. This enables the Promoter to receive a potential life-time residual income source through the System 10. The System 10 provides provide a service for the User as well as rewards the Promoter for promoting the service. Both sides benefit from the mutual, helpful interaction.

After the creation of the User Profile, the Promoter/User GUI Program may be installed into the User's personal computing device, such as a tablet or smartphone computer in step 234. Installing the Promoter/User GUI Program onto the User's personal computing device allows the User to use the System 10 to book a vehicle rental without the use of the Promoter Terminal 120 as the User's personal computer device may be used as a User Terminal 130. The User Terminal 130 allows the User to book vehicle rentals through the System 10, check reservations, check User Profile detail and various other options.

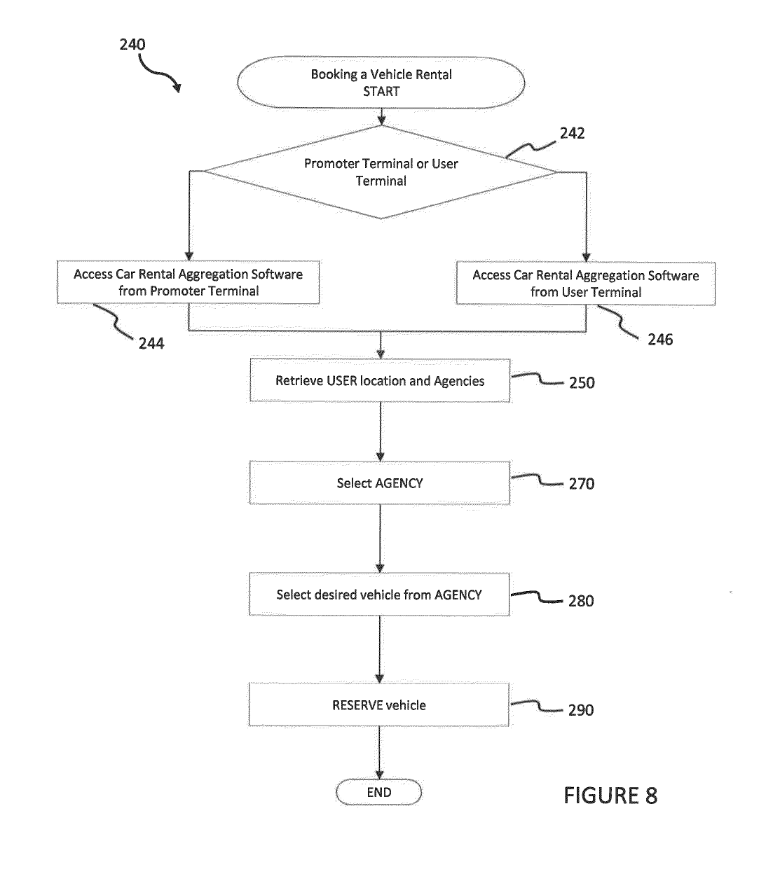

Referring now to FIG. 8, a flow chart depicting the steps of booking a vehicle rental through the System 10 is shown and generally designated 240. The first step 242 of booking a rental vehicle through the System 10 is to access a Promoter Terminal 120 or User Terminal 130. In step 244 a Promoter Terminal is accessed and in the alternative, in step 246 a User Terminal is accessed. After accessing a terminal either using a Promoter Profile or User Profile to access the System 10, the Promoter or User is ready to book a rental vehicle. The location of the User or Promoter is retrieved by the System 10 in step 250 and using the retrieved location, the best two and up to six vehicle rental agencies based on distance from the User or Promoter are displayed along with rental vehicle base price for each agency is displayed for the User or Promoter to select. The User or Promoter then chooses the desired vehicle Rental Agency in step 260. After selecting an Agency, the User or Promoter then choose a vehicle type in step 280. The final step is to confirm the booking and reserve the vehicle in step 290.

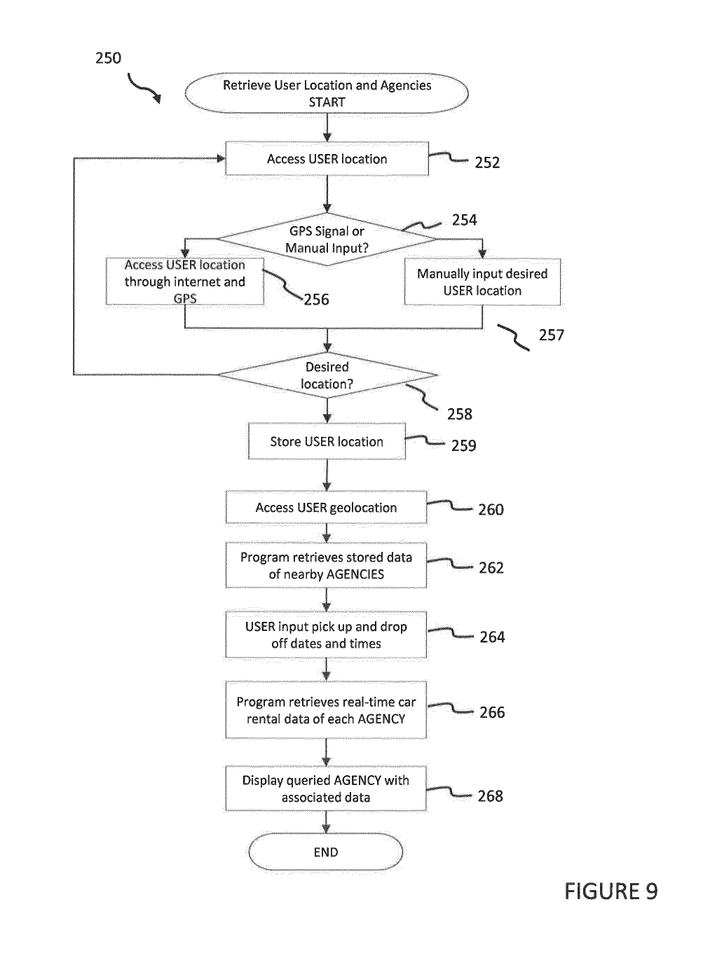

Referring now to FIG. 9, a flow chart depicting step 250 Retrieve User/Promoter Location is shown. Upon accessing the System 10 through the chosen Promoter Terminal 120 or User Terminal 130, the System 10 prompts for the Promoter Terminal 120 or User Terminal 130 location in step 252. The location of the Promoter Terminal 120 or User Terminal 130 can be retrieved either manually or automatically in step 254. For automatic input, step 256 allows the System 10 to access the location of the Promoter Terminal 120 or User Terminal 130 by utilizing GPS and internet. However, if the Promoter or User desires to manually input a location, the Promoter or User has the option to do so in step 257.

For the Promoter Terminal, the control system 122 processes the location of the Promoter Terminal 120 through the use of the onboard GPS transceiver 122 or through the use of measurable physical markers gathered through the various telecommunication connections. The GPS transceiver 122 provides accurate location and time information through the use of GPS satellites. The control system 122 of the Promoter Terminal 120 may also locate itself by using the known physical address of a wired connection in which it is connected or other known methods in the art.

To manually input location data, the Promoter uses the User Interface 127 of the Promoter Terminal 120 to input location data. Manually inserting location data allows a User to book vehicle rental options in a different location than currently located. This aids in pre-planning by allowing the Promoter to book in area without the need to be physically present in the area. For a User Terminal 130, the processes of automatically determining the location and manually inputting the User location are accomplished in substantially the same way.

In step 258, after automatically or manually locating the location, the System 10 prompts whether or not the User wants to choose the location. If a user is unsatisfied with the located location, the User restarts the process at step 252. If a user is satisfied with the located location, the user confirms and the current location of the Promoter or User is sent and stored in the Data Center 100 for future reference during the booking process of the rental vehicle.

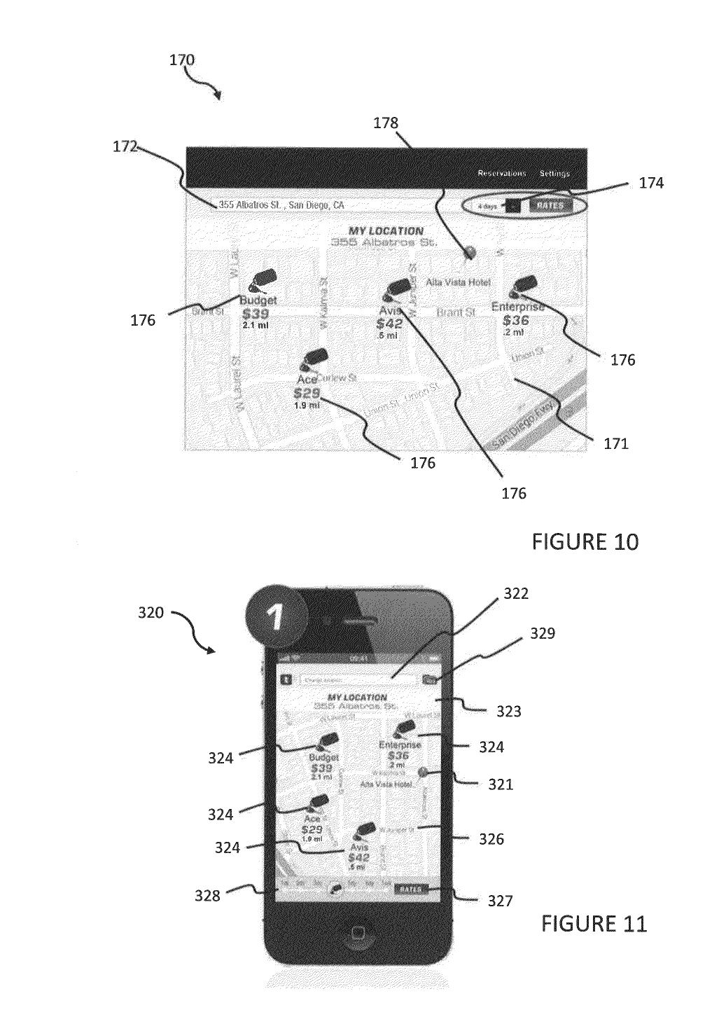

Referring now to FIG. 10, a flow chart depicting the step 260 Selecting Vehicle Rental Agency is shown. After accessing the user location in step 262, retrieved by the Data Center 100 from the Promoter Terminal 120 or the User Terminal and stored in the database storage 110 of the Datacenter 100, the System 10 retrieves stored data of nearby agencies in step 264. The Data Center 100 utilizes proprietary geographic algorithms to determine rental vehicle locations that encompass the nearest two to six locations in its selection of vehicle rental agencies. Afterwards, the Promoter or User then inputs the pick-up and drop of dates and times for the rental vehicle in step 266. Utilizing the location and duration specifications, the Data Center 100 sends a query to the identified agencies which returns real-time prices of the agency's base cost rental vehicles in step 268. The Promoter Terminal 120 or User Terminal 130 then displays the results in steps 270 in an easy to read vehicle Rental Agency Interface 170 shown in FIG. 11.

The vehicle Rental Agency Interface 170 displays a map 171 showing the surrounding map area and pin location 178 of the Promoter Terminal 120 or the User Terminal based on the retrieved location in step 262. The current location is shown in location data filed 172, which may display either the automatic or manually inserted location. The nearest rental vehicle agencies are retrieved and after inputting the duration, either in total rental period or a pick-up and drop-off date in a rental duration data field 174, the map 171 is populated with the nearest four vehicle rental agencies 176. The vehicle rental agencies 176 are displayed as silhouettes on the map with agency names, distance from pin location 178 and the agency's base rental vehicle price.

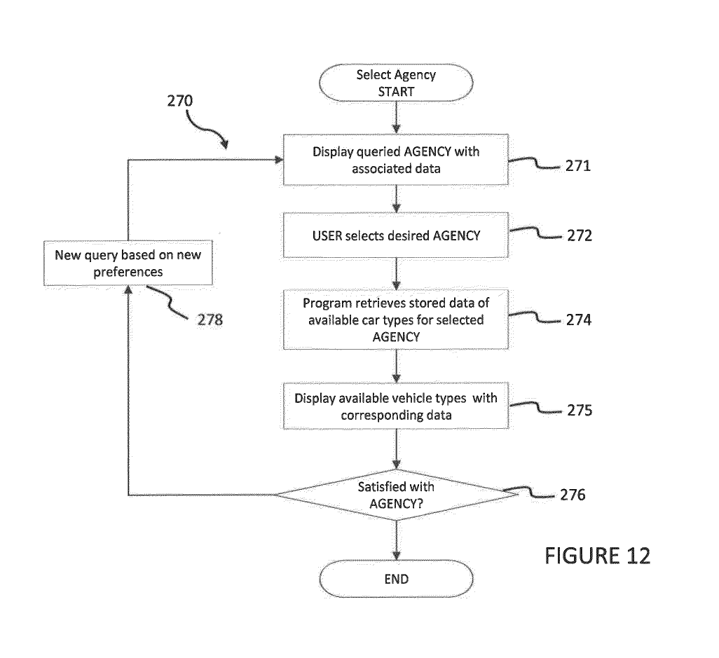

Referring back to FIG. 10, after the vehicle rental agencies are displayed in the vehicle Rental Agency Interface 170, the User selects a desired vehicle rental agency from the graphical user interface in step 272. The vehicle rental agency is selected through the graphical user interface either through touch screen interface or alternative interface device such as a mouse. After the Agency is selected, the Data Center 100 retrieves a list of available vehicle types and prices from the Agency in step 274. Upon selecting the Agency, the Data Center 100 sends a request to the Agency for real-time results of five to six additional vehicle class prices via Worldspan GDS technology. The prices of the five to six additional vehicles will be displayed for a modified list in a subsequent Rental Vehicle Interface 180 (shown in FIG. 12), giving the user additional rental vehicle options.

The Rental Vehicle Interface 180 displays information with representative pictures of the available rental vehicles, corresponding vehicle information and details on the rental price. The Rental Vehicle Interface 180 displays the rental vehicle information in a picture column 182, a vehicle description column 184, and rental price column 186 to provide direct comparisons between the available vehicles at the chosen rental agency. On the Rental Vehicle Interface 180 there are also pick-up data fields 187 and drop-off data fields 188 in which the User may modify the pick-up date and time and drop-off date and time. The Rental Vehicle Interface 180 also has a submit button 181 and a back button 189.

Referring again to FIG. 10, in step 278 a user may select from the list of vehicles for the selected agency or select a new agency in the Rental Vehicle Interface 180. From the Rental Vehicle Interface 180, the Promoter or User may proceed to select the available vehicle and hit the submit button 189 or may hit the back button 181 to return to the Rental Agency Interface 170 to select a new rental agency in step 270.

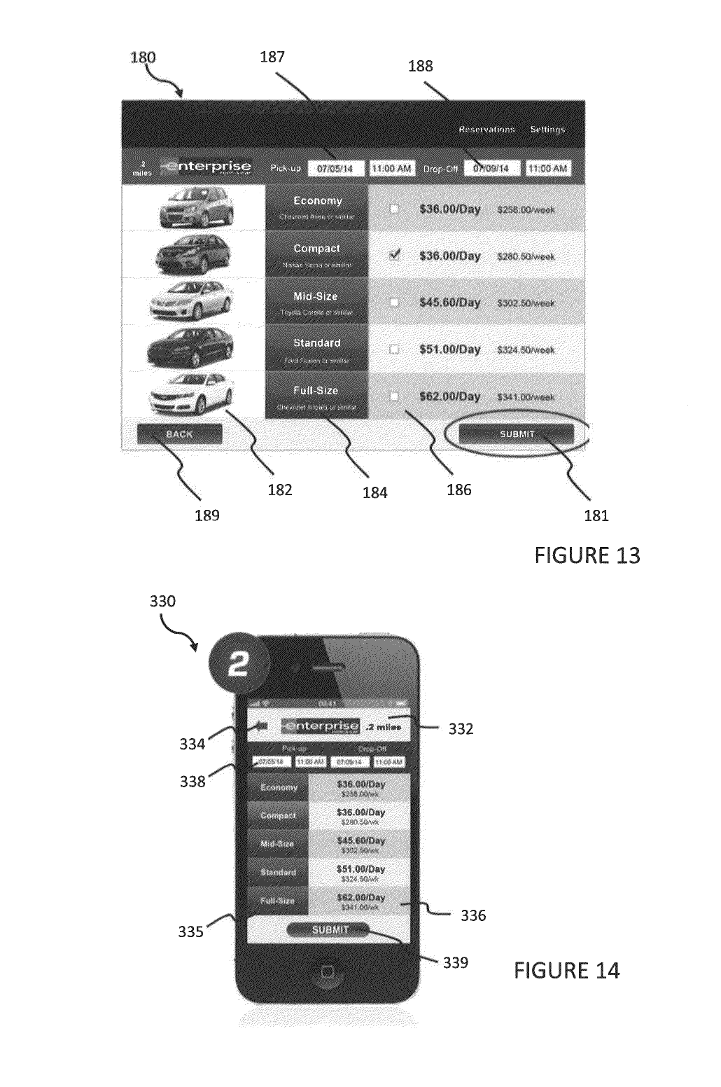

Referring now to FIG. 13, a flow chart depicting the step 280 of Selecting a Vehicle is shown. After choosing a vehicle rental agency and having the list of rental vehicles available from the vendor displayed in a Rental Vehicle Interface 180, the User selects a rental vehicle from the Rental Vehicle Interface 180 and sends a Request to the Agency in step 282. Sending the request to book the rental vehicle will launch a reservation submission to the chosen Agency. The request sends an additional query to the Agency for real-time total cost including all taxes and fees. This query result will be displayed in the Promoter Terminal 120 or User Terminal 130 in step 284 and represent name of Agency, itemized total cost of chosen rental vehicle, and chosen rental vehicle description. The request results will be displayed in a Reservation Interface 190 shown in FIG. 14.

The Reservation Interface 190 shown in FIG. 14 displays the results of the Request which includes an agency detail field 191, a total price field 192, a representative picture of the vehicle 193, a rental vehicle description field 194, an itemized total cost of the chosen vehicle field 195, a rental duration period 196 showing the pick-up date and time and drop-off date and time, a reserve button 197 and a back button 198. If the chosen rental vehicle and rental details are acceptable by the Promoter or User, the reserve button 197 is selected. If the chosen rental vehicle is not acceptable the back button 198 is selected which brings the User back to the Rental Vehicle Interface 180 to choose a new vehicle.

Referring again to FIG. 13, in step 286 the Promoter or User has a choice to accept or decline the selected vehicle. If the User declines, the process of selecting a vehicle is restarted at step 282. If a user accepts the rental vehicle, the user proceeds to step 288 where a request to reserve the vehicle is sent to the agency.

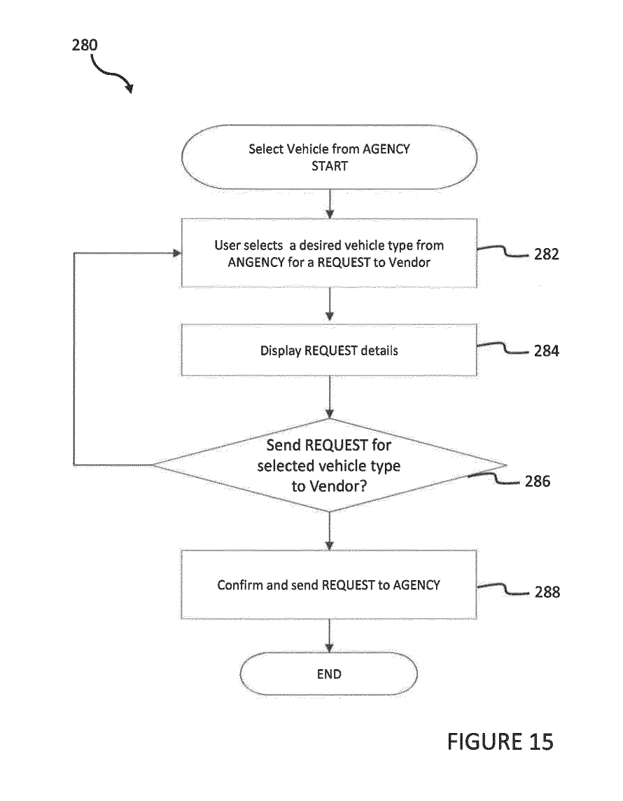

Referring now to FIG. 15, a flow chart depicting the step 290 User Reservation Confirmation 290 is shown. Clicking the Reserve button will launch a reservation submission to chosen Agency. The Request for Reservation is submitted by the Promoter or User using the Promoter Terminal 120 of User Terminal 130 to the Data Center 100 in step 280, User Selection of Vehicle from Selected Vendor. After receiving the booking confirmation from the Promoter Terminal 120 or the User Terminal 130, the Data Center 100 with send the confirmation to the Agency in step 292 which will return a confirmation reservation including a reservation number in real-time to the Data Center 100 in step 294.

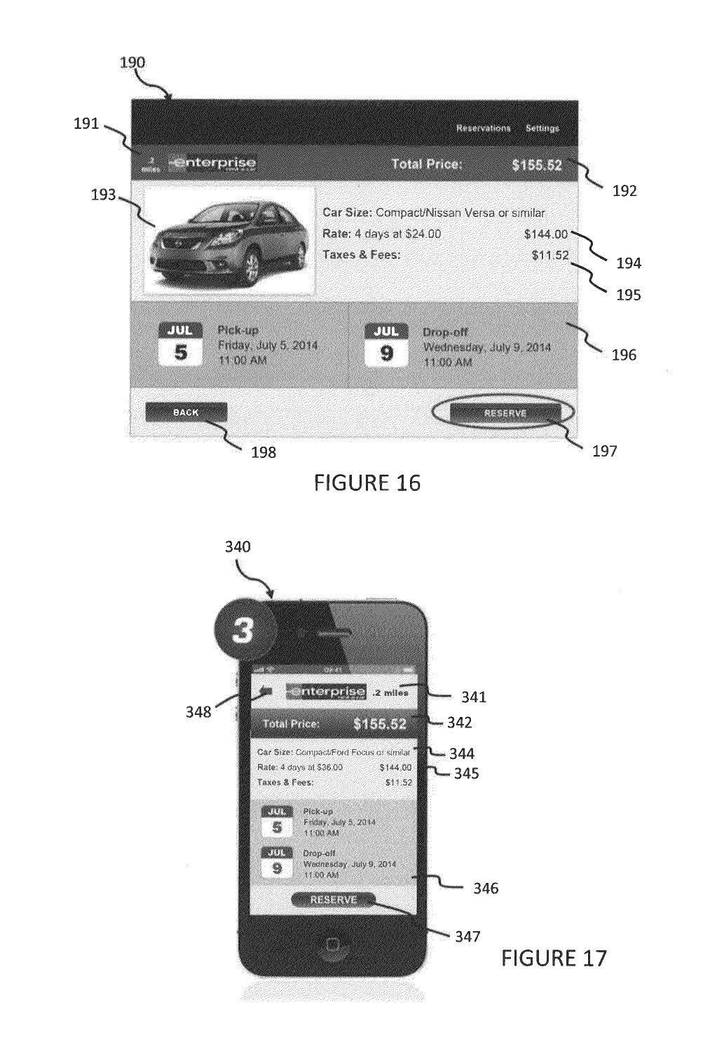

The Data Center 100 sends all of the information to the Promoter Terminal 120 or the User Terminal 130. The reservation information will be displayed on the fourth screen in a Reservation Confirmation Screen 300 shown in FIG. 16. The Reservation Confirmation Screen 300 shown in FIG. 16 includes an Agency name field 301, an Agency information field 305, an itinerary field 304, a vehicle type field 306, a rental vehicle rate field 307, a taxes and fees field 308, a confirmation number field 302 and a total price field 303.

In step 296, a confirmation is sent to the Promoter making the reservation or to the User and its associated Promoter. The confirmation is also stored in the Data Center 100 database storage 110. A final copy of the reservation compilation will be logged in the reservation database file within the database storage 110 of the data center 100 and available for anytime access as well. The Promoter making the reservation or associated with the User making the reserving will be associated with the booking in step 298. Upon payment of the vehicle rental booking, the associated Promoter with the User profile will be credited.

Referring now to FIG. 17, the Rental Agency Interface of the User Terminal 130 is shown and generally designated 320. As shown, the User Terminal 130 is installed onto a mobile smartphone. The Rental Agency Interface 320 of the User Terminal 130 is substantially similar to the Rental Agency Interface 170 and includes a map 326 showing the surrounding map area after retrieving the location of the User Terminal 130 manually or automatically. A location data filed 322 allows the User to change the location if desired. The current location is shown in a location data field 323 and is represented on the map 326 by a pin locator 321. To find the nearest vehicle rental agencies, the duration period for the rental is selected in a rental duration data filed 328 and a rate button 327 is pressed to populate the rental agencies 324 on the map 326. The vehicle rental agencies 324 are displayed as silhouettes on the map with agency names, distance from user's location and the vendors base rental vehicle price. The Rental Agency Interface 320 of a User Terminal 130 further includes a reservation tab 329.

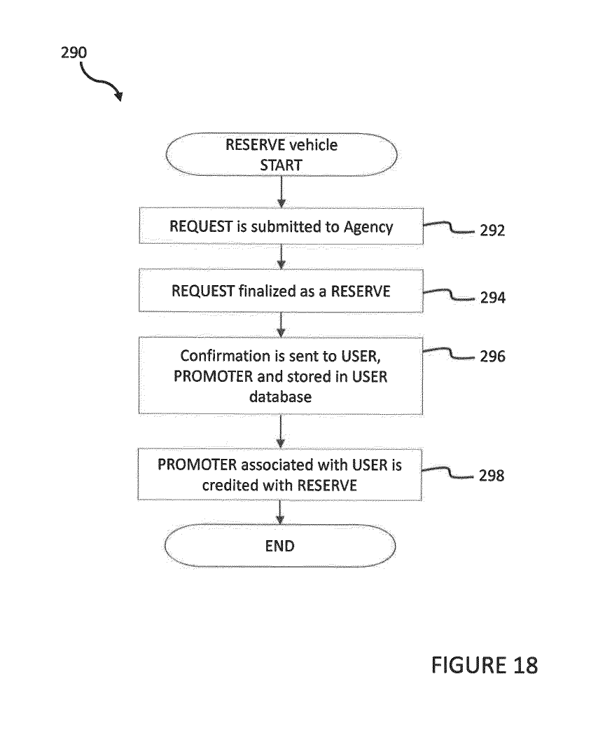

Referring now to FIG. 18, the Rental Vehicle Interface 330 of the User Terminal 130 is shown. The Rental Vehicle Interface 330 for a User Terminal 130 is substantially similar to the Rental Vehicle Interface 180. The Rental Vehicle Interface 330 displays information of the selected rental agency in the rental agency field 332. The rental vehicle information is displayed in a vehicle description column 335 and the rental price of the vehicle is displayed in a rental price column 336 to provide direct comparisons between the available vehicles at the chosen rental agency. On the Rental Vehicle Interface 330 there are also reservation data fields 338 in which the User may modify the pick-up date and time and drop-off date and time. There is also a submit button 339 to confirm the chosen rental vehicle or a back button 334 to return to the Rental Agency Interface 320.

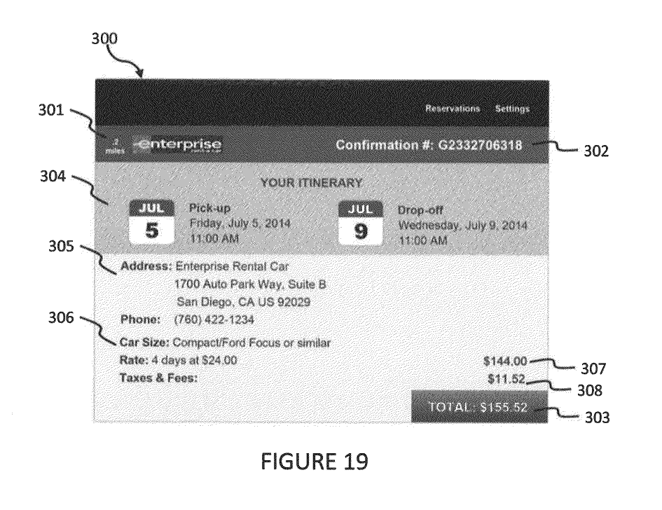

Referring now to FIG. 19, the Reservation Interface 340 for the User Terminal 130 is shown. The Reservation Interface 340 displays the results of a Request which includes the details of the agency in an agency field 341, the total price in a total price field 342, a rental vehicle description in a rental vehicle description field in an itinerary field 344, an itemized total cost of the chosen vehicle including taxes in an itemized cost field 345, details of the rental period in an itinerary field 346, a reserve button 347 and a back button 348. If the chosen rental vehicle and rental details are acceptable by the User, the reserve button 347 is selected. If the chosen rental vehicle is not accepted the back button 348 is selected which brings the User back to the Rental Vehicle Interface 330 to choose a new vehicle.

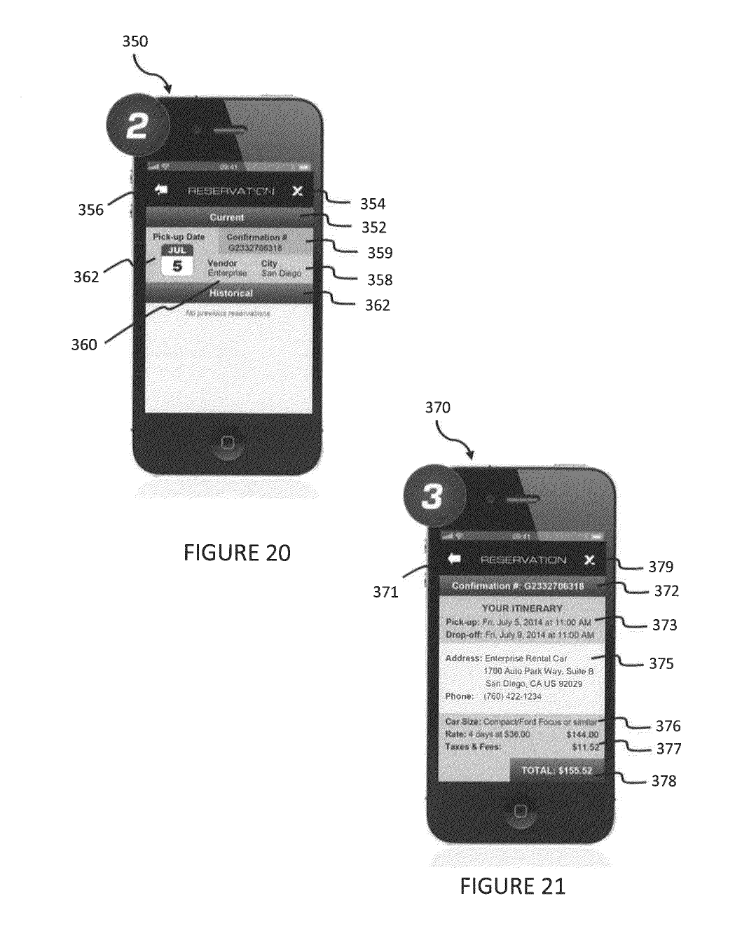

Referring now to FIG. 20, a Reservation Information Interface 350 is shown. By selecting the reservation tab 329 on the Rental Agency Interface 320 for the User Terminal 130, the Reservation Information Interface 350 is accessed. The Reservation Information Interface 350 includes a current reservations data field section 352 and a historical reservation section 362. Additionally, the Reservation Information Interface 350 includes a back button 356 and a cancel button 354. The back button brings the user to the Rental Agency Interface 320 and the cancel button 354 closes the program. (is this correct?) Under each section, if applicable, Reservation Summary 358 is displayed. A reservation summary 358 includes a confirmation number data field 359, vendor name data field 360, city data field 361, and pick-up date data field 362. By clicking on the reservation summary 358, a more detailed reservation summary 370 is shown

Referring now to FIG. 21, a detailed reservation summary 370 is shown. The detailed reservation summary 370 includes a confirmation number data field 372, itinerary data field 373, agency detail data field 375, vehicle type data field 376, vehicle rental fee data field 377, and a total cost data field 378. The Detailed Reservation Summary 370 also includes a back button 371 and a cancel button 379.

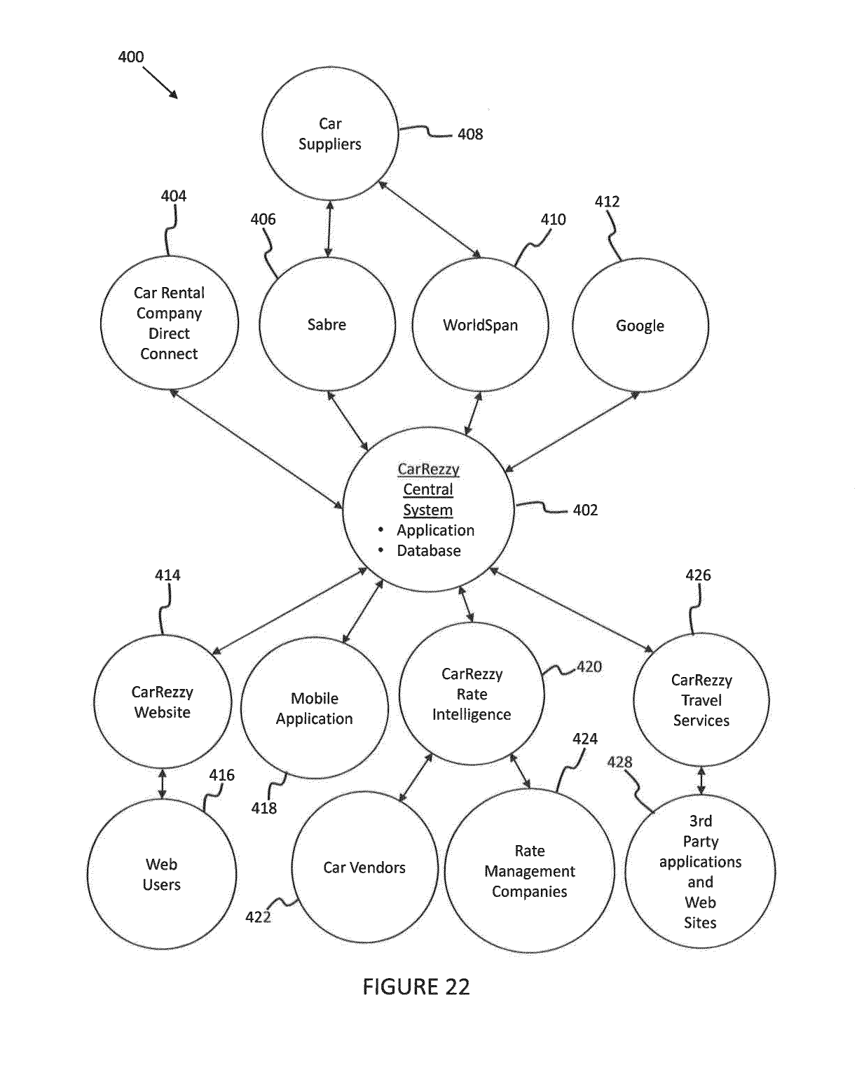

Lastly, referring to FIG. 22, a schematic of the rental system and generally referred to as 400. System 400 consists of a central system 402. Central system 402 consists of an application and a database. Central system 402 in turn connects to several external services associated with rentals. Connected to central system 402 is car rental company direct connect, which allows rental companies, such as Avis and Hertz, to directly receive rental information, such as type of car available, length of time available, and cost of rental. Central system 402 may also connect to other car suppliers through intermediate services such as Sabre 406 and WorldSpan 410, which are Global Distribution Services (GDS). Sabre 406 is a web-based service used by travel agents and other online aggregators to secure rentals for clients. WorldSpan 410 is a universal Application Program Interface (API) that performs the same functions as Sabre 408 in that it provides an interface for travel agents and other online aggregators to secure rentals for clients. Also connected to central system 402 is Google 412. Google 412 does not receive rental information from central system 402 but instead provides Geo Location Services to central system 402 to allow for the generation of maps showing the location of rental agencies in relation to the location of a user (See FIGS. 10 and 11).

Central system 402 interfaces with other services associated with rentals. Website 414 connects web users 416 to central system 402 to facilitate rentals through the web interface. End users may also use mobile application 418 on a mobile computing device, such as a smart phone or tablet. Mobile application 418 allows a user to search, locate, and select rentals similar to capabilities of website 414.

Rate intelligence 420 provides a collection of rates from various rental agencies to car vendors 422 and rate management companies 424. Car vendors 422 may be companies such as Hertz, Avis, and Budget. Rate management companies 424 collect and distribute rental information, typically for a fee, to rental agencies. The information provided to car vendors 422 may include car type available and the length of time the rental is available to rent. Other information, such as rental cost, available discounts, and rental specials may also be provided to car vendors 422 and rate management companies 424. Providing information from rate intelligence 420 to car vendors 422 and rate management companies 424 typically provides cheaper and more cost effective access to rental information from multiple sources.

Also interfacing with central system 402 is travel services 426, which provides information to third party applications and websites 428 such as taxi cab companies. When a user enters his or her location into central system 402, their location information may be transmitted to a third party 428 to allow the third party to provide transportation or other travel related services to the user. This aspect of system 400 allows a user to utilize commercial transportation services when the user is not close enough to a rental agency to make a rental feasible. Such a service may also be beneficial when a user lacks a way to get to a rental agency. In certain embodiments of the present invention, a user may use a third party 428 to secure transportation to a rental location where a rental is waiting for the user upon his or her arrival.

While there have been shown what are presently considered to be preferred embodiments of the present invention, it will be apparent to those skilled in the art that various changes and modifications can be made herein without departing from the scope and spirit of the invention.

What is claimed is:

1. A system for renting a vehicle consisting of:
one or more user terminals;
one or more rental agencies;
a promoter terminal;
a data center comprising a control system, a timer/clock, a user interface, a communication interface, and a database; and
a means for interconnecting the one or more users, the one or more rental agencies, the promoter terminal, and the data center.

2. The system for renting a vehicle of claim 1, wherein the control system controls the overall functionality and coordination of the data center.

3. The system for renting a vehicle of claim 1, wherein the control system operates with a proprietary database software program.

4. The system for renting a vehicle of claim 1, wherein the timer/clock is configured to ensure that the control system, the user interface, the communication interface, and the database stay synchronized to the timer/clock.

5. The system for renting a vehicle of claim 1, wherein the user terminal may be a personal computer, a tablet, or a smartphone.

6. The system for renting a vehicle of claim 1, wherein the database stores at least map data, profile data, and reservation data.

7. The system for renting a vehicle of claim 6, wherein profile data is stored for users and promoters.

8. The system for renting a vehicle of claim 1, wherein the promoter terminal location is determined by an onboard Global Positioning System (GPS) transceiver.

9. The system for renting a vehicle of claim 1, wherein the promoter terminal location is determined by using measurable physical markers gathered through the means for interconnecting the one or more users, the one or more rental agencies, the promoter terminal, and the data center.

10. The system for renting a vehicle of claim 1, wherein the promoter terminal is configured to synchronize itself with the data center to receive real time updates on local vehicle rental agencies.

11. The system for renting a vehicle of claim 10, wherein the real time updates contain information for the availability and pricing of the rental vehicle.

12. The system for renting a vehicle of claim 1, wherein the promoter terminal is configured to accept parameters required to book a rental vehicle.

13. The system for renting a vehicle of claim 12, wherein the parameters consist of a rental duration, a vehicle rental company, and a vehicle type.

14. The system for renting a vehicle of claim 1, wherein the data center utilizes Worldspan Global Distribution System technology to communicate with the one or more rental agencies.

15. The system for renting a vehicle of claim 1, wherein the system is configured to use geolocation services to generate a map showing user, promoter, and rental agency locations.

16. A method of booking a rental vehicle, comprising the steps of:
providing a promoter terminal for use by a promoter;
providing a user terminal for use by a user;
determining and storing a user's location;
inputting rental parameters into the user terminal;
transmitting the rental parameters to a data center;
displaying available rental agencies on the user terminal based on the rental parameters and user location;
selecting a desired rental agency;
displaying available vehicles based on the rental parameters and user location; and
reserving one of the specific vehicles.

17. The method of booking a rental vehicle of claim 16, wherein the user's location is determined through Global Positioning System.

18. The method of booking a rental vehicle of claim 16, wherein the user's location is manually entered.

19. The method of booking a rental vehicle of claim 16, wherein a confirmation is sent to the user, the promoter, and the data center for storage in a database.

20. The method of booking a rental vehicle of claim, further consisting of the step of crediting the promoter associated with the user for the reserving one of the specific vehicles.
